(19) United States
(12) Patent Application Publication
(10) Pub. No.: US 2025/0297103 A1
(43) Pub. Date: Sep. 25, 2025

(54) Binder and manufacturing methods

(71) Applicant: ArcelorMittal, Luxembourg (LU)

(72) Inventors: Paul PERNOT, Metz (FR); Tatiana ROZHKOVA, Hombourg Haut (FR)

(21) Appl. No.: 18/862,800

(22) PCT Filed: Jun. 8, 2023
(86) PCT No.: PCT/IB2023/055936

§ 371 Date: Nov. 4, 2024

(30) Foreign Application Priority Data
Jun. 14, 2022 (WO) PCT/IB2022/055500

(51) Int. Cl. C08L 91/00

(52) U.S. Cl. CPC C08L 91/00; C08L 2205/20; C08L 2207/32

(57) ABSTRACT

A binder for extruded, pelletized, briquetted, or agglomerated material, the binder having a composition including from 80% to 90% in weight of a pyrolysis oil resulting from the pyrolysis of biomass and from 10% to 20% in weight of thermoplastics.

The present invention is related to a binder to produce briquettes, pellets or any other agglomerated material. The present invention is also related to a manufacturing method of said binder and to a manufacturing method of briquettes using said binder.

### BACKGROUND

Steel can be currently produced at an industrial scale through two main manufacturing routes. Nowadays, most used production route consists in producing pig iron in a blast furnace, this process relying on two main raw materials; sintered iron ore to be reduced and coke as reducing agent. Both those raw materials require respectively a sinter plant and a coking plant to be produced, both of those plants being big CO2, and more globally pollutants, emitter.

### SUMMARY OF THE INVENTION

In order to reduce its environmental footprint steel industry is looking for solutions to produce iron and/or carbon-bearing materials without the need of the sintering and coking processes.

To do so new cold-based manufacturing processes are considered, such as extrusion, briquetting or pelletizing. All those processes require the use of a binder.

Patent JP 2018-165301 A describes a method in which charcoal briquettes are formed using a binder formed by mixing waste plastic and woody biomass in a solvent made of coal-tar.

However, this kind of binder is based on fossil carbon and comprises toxic compound such as BTX which are mixtures of Benzene, Toluene, and Xylene and Polycyclic Aromatic Hydrocarbons (PAH). Those are pollutants which have been determined to be highly toxic, mutagenic, carcinogenic, teratogenic, and immune-toxicogenic to various life forms.

There is so a need for a binder with a reduced environmental, including carbon, footprint. There is also a need for materials to be used in steelmaking industry which have a reduced carbon footprint.

It is an object of the present invention to provide a binder comprising from 80% to 90% in weight of a pyrolysis oil resulting from the pyrolysis of biomass and from 10% to 20% in weight of thermoplastics.

The binder of the present invention may also comprise the following optional characteristics considered separately or according to all possible technical combinations:
thermoplastics is chosen among polyethylene, polystyrene, polycarbonate or styrene derivate,
thermoplastics is expanded polystyrene, and
biomass is lignocellulosic biomass.

The present invention provides a binder for extruded, pelletized, briquetted, or agglomerated material, the binder comprising from 80% to 90% in weight of a pyrolysis oil resulting from the pyrolysis of biomass and from 10% to 20% in weight of thermoplastics.

The present invention is also related to a manufacturing method of a binder comprising mixing and heating at a temperature from 150°° C. to 220° C., a pyrolysis oil resulting from the pyrolysis of biomass with thermoplastics to produce a binder in such proportions that said binder comprises from 80% to 90% in weight of pyrolysis oil and from 10% to 20% in weight of thermoplastics.

The manufacturing method of the present invention may also comprise the following optional characteristics considered separately or according to all possible technical combinations:
the pyrolysis of biomass is performed at a temperature from 450° C. to 700° C.,
the method further comprises the steps of pyrolysis of a biomass to produce a biochar and a pyrolysis oil, removing water from the pyrolysis oil so that final content of water in the dewatered pyrolysis oil is inferior to 5 wt. % and mixing said dewatered pyrolysis oil with thermoplastics to produce a binder in such proportions that said binder comprises from 80 to 90 wt. % of dewatered pyrolysis oil and from 10 to 20 wt. % of thermoplastics,
the water removal step is chosen among a decantation step, a fractional condensation step and a fractional crystallisation step,
after the water removal step the dewatered pyrolysis oil is subjected to a decarbonisation step before being mixed with thermoplastics,
thermoplastics are densified before mixing, and
the hot binder is cast in mould to produce binder ingot.

The present invention is also related to a manufacturing method of a briquette comprising the step of mixing at least one material with a binder according to anyone of the following combinations and subjecting said mixture to a compression step to form a briquette.

The briquette manufacturing method of the present invention may also comprise the following optional characteristics considered separately or according to all possible technical combinations:
the at least one material is chosen among coking coal, biochar, iron ore or a steelmaking by-product,
the material is biochar, and
the material is roll mill sludge.

The present invention is also related to a raw material comprising a binder according to the present invention and at least one material chosen among coking coal, biochar, iron ore or a steelmaking by-product.

Other characteristics and advantages of the present invention will emerge clearly from the description of it that is given below by way of an indication and which is in no way restrictive.

### DETAILED DESCRIPTION

A binder according to the present invention comprises from 80% to 90% in weight of a pyrolysis oil resulting from the pyrolysis of biomass and from 10% to 20% in weight of thermoplastics.

Pyrolysis process is the thermal decomposition of materials at elevated temperatures in an inert atmosphere. The pyrolysis of biomass produces a biochar or bio coal, a pyrolysis gas (or syngas) and a pyrolysis oil, also called bio-crude or bio-oil. Thermal conversion of biomass, which is done under oxygen-free conditions process, allows to remove volatile organic compounds and cellulose components from the feedstock and create a solid biofuel with characteristics like the ones of fossil coal.

In a method according to the present invention the pyrolysis process is preferentially performed at a temperature from 450° C. to 700° C. to maximise biochar and pyrolysis oil yields. As a matter of example, the pyrolysis may be performed using a heated screw, biomass is charged into a fuel container and is extracted by a feeding screw from the container up to the pyrolysis screw where it is heated to a temperature from 450° C. to 700° C. Biochar thus formed is extracted at the end of the screw and stored in a container. Pyrolysis gas is collected through a pipe up to a gas cooler, for example a condenser, which separate the crude pyrolysis oil from the gas. Microwave-assisted pyrolysis (MAP) could also be used.

Biomass is renewable organic material that comes from plants and animals. Biomass sources include notably wood and wood processing wastes such as firewood, wood pellets, and wood chips, lumber and furniture mill sawdust and waste, and black liquor from pulp and paper mills, agricultural crops and waste materials such as corn, soybeans, sugar cane, switchgrass, woody plants, and algae, and crop and food processing residues, but also biogenic materials in municipal solid waste such as paper, cotton, and wool products, and food, yard, and wood wastes, animal manure and human sewage. In the sense of the present invention, biomass may also encompass plastics residues, such as recycled waste plastics like Solid Refuse Fuels or SRF.

In a preferred embodiment, biomass is lignocellulosic biomass.

In order to form the binder, the pyrolysis oil is mixed with thermoplastics in such proportions that said binder comprises from 80% to 90% in weight of pyrolysis oil and from 10% to 20% in weight of thermoplastics, this mixing is performed at a temperature from 150° C. to 220° C.

The thermoplastics are preferentially chosen among polyethylene, polystyrene, polycarbonate or styrene derivate and are more preferentially expanded polystyrene. Polystyrene may be used under its different forms (expanded polystyrene EPS, dense polystyrene), recycled polystyrene can also be used. The amount of thermoplastics with the pyrolysis-oil governs the thermoplastic properties of the binder. Above 20 wt. % of thermoplastics produce a harden bio-binder at room-temperature which may then be fragile, while less than 10 wt. % of waste thermoplastics produce a more malleable bio-binder at room temperature which is difficult to store and manipulate.

In a preferred method of producing a binder according to the present invention, after the pyrolysis of the biomass, and before being mixed with thermoplastics, the pyrolysis oil is subjected to a water removal step. Most of the formed water is chemically produced during the pyrolysis process and does not come from the biomass material. This water removal step allows to limit acidity and corrosion risks of the produced binder and to increase efficiency of the production process of the binder. Indeed, water presence may slow down the production and increase energy needs.

This water removal step may be performed with different technologies, among them being decantation, fractional condensation, or fractional crystallisation.

In a preferred embodiment the low-density thermoplastics like expanded Polystyrene (EPS) are subjected to a pre-treatment step before mixing with pyrolysis oil, which is a densification step, such as a chemical densification step as described in patent WO 1998 023 672. In a preferred embodiment solvent used for the densification step is d-limonene. This allows to reduce the volume of thermoplastics to be mixed with the pyrolysis oil to reach the appropriate binder composition.

In a preferred embodiment, the hot binder resulting from the mixing is cast in mould to form ingot at room temperature. This allows an easier handling and storage of the binder.

The binder according to the present invention may be used for the manufacturing of extruded, pelletized, briquetted, or agglomerated material. In a manufacturing method of a briquette according to the present invention, at least one material is mixed with a binder as previously described and the mixture is subjected to a compression step to form a briquette. The at least one material may be chosen among coking coal, biochar, iron ore or a steelmaking by-product.

Other manufacturing technologies might be used, such as extrusion, pelletizing or agglomeration to produce a raw material using a binder according to the present invention and at least one material chosen among coking coal, biochar, iron ore or a steelmaking by-product. The steelmaking by-product is preferably roll mill sludge. It may also be iron fines.

In a preferred embodiment biochar resulting from the pyrolysis of biomass is mixed with a binder according to the present invention comprising the pyrolysis oil from this same pyrolysis process and subjected to the briquetting step to produce biochar briquettes. These biochar briquettes may then be charged for example in a blast furnace, or in an electric arc furnace, smelting furnace or direct reduction furnace as carbon source.

In another embodiment the binder is mixed with oxidized iron ore and biochar and subjected to a pelletizing step to form combined iron-biochar pellets. Those pellets may then be subjected to a direct reduction process to reduce oxidized iron.

### Example 1

Six binders B1 to B6 were prepared using different basis to be mixed with thermoplastics.

Binder B1 to B4 are binders according to the present invention and comprise 85% in weight of pyrolysis oil resulting from the respective pyrolysis of straw, beech, saw-dust and pine tree at 450° C. during 45 minutes at a heating rate of about 10° C./min in a pyrolysis screw equipment as previously described and 15% in weight of Expanded Polystyrene (EPS).

B5 is a binder composed of 85 wt. % coal tar +15 wt. % EPS and B6 is a binder composed of 85 wt. % coal tar sludges +15 wt. % EPS. B5 and B6 are according to prior art.

Production process of the six binders was the same, mixing of the respective proportion of oil/coal tar with EPS at a temperature of 250° C. during 2 hours. Chemical composition of the six binders have then been analysed, results being illustrated in table 1.

TABLE 1

| | B1 | B2 | B3 | B4 | B5* | B6* |
|---|---|---|---|---|---|---|
| Basis | Oil from | Oil from | Oil from | Oil from | Coal Tar | Coal Tar |
| | Straw | Beech | Saw | Pine | | sludges |
| | pyrolysis | pyrolysis | Dust | Tree | | |
| | | | pyrolysis | pyrolysis | | |
| Sulphur | 0.09 | 0.01 | 0.01 | 0.02 | 0.35 | 0.47 |
| (wt. % on | | | | | | |
| dry basis) | | | | | | |
| BTX | 0.6 | 0.2 | 0.2 | 3 | 202.7 | 100.7 |
| (mg/kg) | | | | | | |
| HAP | 37 | 65 | 8.9 | 98.2 | 54100 | 114470 |
| (mg/kg) | | | | | | |

(*prior art)

The binders according to the present invention (B1 to B4) contain less Sulphur, less BTX and less HAP, they are thus less detrimental to the environment.

### Example 2

A set of biochar briquettes was prepared using biochar as filler and a binder according to the present invention. Beech wood was used as biomass. Resulting pyrolysis oil was mixed with 15 wt. % of EPS to form a binder according to the present invention. The biochar was crushed so that the final granulometry is below 2 mm for at least 70% of biochar particles. Then crushed biochar was mixed at a ratio 80 wt. % of biochar, 20 wt. % of binder at a temperature of around 150° C. Mixture is then roll-pressed in a roll-press machine with a hydraulic pressure of around 700 bar to ensure a linear pressure along wheels having a 160 mm width of 3 tons/cm of width of wheels.

A higher amount of binder is necessary compared to coal briquetting wherein around 10 wt. % is usually added. This is due to the higher porosity of biochars versus coal. Cold compressive strength of each briquette was then measured. 20 determinations were done on individual briquettes pressed with an Adamel hydraulic press operating in the range 0-2000 N.

All measurements were between 1000 and 2000 N which is a sufficient value to consider use of those briquettes for charging into a blast furnace as replacement for coke.

With a binder according to the present invention it is thus possible to produce biochar briquettes with a reduced environmental footprint which are suitable for use in a blast furnace.

### Example 3

A first set of briquettes was prepared, using same briquetting process as for example 2, with 90 wt. % of coal mixed with 10 wt. % of a binder according to the present invention having same composition of the binder of example 2.

A second set was prepared, using same briquetting process, with 90 wt. % of coal mixed with 10 wt. % of petroleum pitches as binder, a binder according to prior art.

Cold compressive strength of each briquette was then measured using same machine as described in previous example.

Mean value of the compressive strength of the briquettes produced with the binder according to the present invention was of 1890 N which is higher than the mean value of 650 N for the briquettes produced with the binder according to prior art.

With the same amount of binder according to the present invention as prior art binder it was possible to prepare briquettes with a higher compressive strength. This compressive strength is a key characteristic of the briquettes to ensure they may be handled, transported or stored without being deteriorated.

### Example 4

Iron briquettes were prepared using 8 wt. % of a binder according to the present invention with 92 wt. % in weight of iron ore concentrate containing 65.8 wt. % of iron.

The binder used comprises 85 wt. % of pyrolysis oil from beech wood with 15 wt. % EPS.

Briquette properties were then analysed, iron content of the briquettes was 63.3 wt. % As a comparison a briquette of sintered ore manufactured with same iron ore has an iron content comprised between 56 and 58 wt. %. Cold strength of the briquette was high and superior to 20 MPa which ensure handling and charging in good conditions without risk of deterioration of the briquette.

What is claimed is:

1-16. (canceled).

17. A binder for extruded, pelletized, briquetted, or agglomerated material, the binder comprising:
a pyrolysis oil being from 80% to 90% in weight of the binder and resulting from a pyrolysis of biomass;
thermoplastics from 10% to 20% in weight of the binder.

18. The binder according to claim 17 wherein the thermoplastics is chosen from at least one of the group consisting of: polyethylene, polystyrene, polycarbonate and styrene derivate.

19. The binder according to claim 17 wherein the thermoplastics are expanded polystyrene.

20. The binder according to claim 17 wherein the biomass is lignocellulosic biomass.

21. A method to produce a binder comprising:
mixing and heating at a temperature from 150° C. to 220° C. a pyrolysis oil resulting from pyrolysis of a biomass with thermoplastics to produce a binder, the binder comprising from 80% to 90% in weight of the pyrolysis oil and from 10% to 20% in weight of the thermoplastics.

22. The method according to claim 21 wherein the pyrolysis of biomass is performed at a temperature from 450° C. to 700° C.

23. The method according to claim 21 wherein the pyrolysis of the biomass produces the pyrolysis oil and the biochar and further comprising the steps of:
removing water from the pyrolysis oil to produce a dewatered pyrolysis oil so that a final content of water in the dewatered pyrolysis oil is inferior to 5 wt. %; and
mixing the dewatered pyrolysis oil with the thermoplastics to produce the binder comprising from 80 to 90 wt. % of the dewatered pyrolysis oil and from 10 to 20 wt. % of the thermoplastics.

24. The method according to claim 23 wherein the water removal step is chosen from the at least one of the group consisting of: a decantation step, a fractional condensation step and a fractional crystallisation step.

25. The method according to claim 23 wherein after the water removal step the dewatered pyrolysis oil is subjected to a decarbonization step before being mixed with the thermoplastics.

26. The method according to claim 21 wherein the thermoplastics are densified before mixing.

27. The method according to claim 21 wherein the biomass is straw and the binder is cast in a mold to produce binder ingot.

28. A method of manufacturing a briquette comprising the step of:
mixing at least one material with the binder according to claim 17 and subjecting the mixture to a compression step to form a briquette.

29. The manufacturing method according to claim 28 wherein the at least one material is chosen from at least one of the group consisting of: coking coal, biochar, iron ore and a steelmaking by-product.

30. The manufacturing method according to claim 29 wherein the material is biochar.

31. The manufacturing method according to claim 29 wherein the material is roll mill sludge.

32. A raw material comprising:
the binder according to claim 17; and
at least one material chosen among coking coal, biochar, iron ore or a steelmaking byproduct.
